(19) United States
(12) Patent Application Publication
(10) Pub. No.: US 2005/0108406 A1
(43) Pub. Date: May 19, 2005

(54) System and method for dynamically generating a customized menu page

(75) Inventors: Fisher Chen-Yin Lee, Taipei (TW); Ann Lee, Taipei (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: DynaLab Inc.

(21) Appl. No.: 10/703,959

(22) Filed: Nov. 7, 2003

(51) Int. Cl. G06F 15/16

(52) U.S. Cl. 709/228

(57) ABSTRACT

The present invention provides a method, system, and software for dynamically generating a customized menu page on a display of a client system coupled to a network, such as the Internet. The menu page includes a number of selectable icons, each associated with a particular Web site, service, Web guide channel, etc., that the user is likely to wish to access. The menu page is “customized” in the sense that each menu page is generated based on each user's network log history and preferences, as stored in a user preference database, so as to present only those information sources/services that he/she would want to access. The menu is “dynamically” generated in the sense that the user preference database is constantly updated so as to present a menu page that reflects the user's most recent preferences and history.

### FIELD OF THE INVENTION

The invention is directed to user-interface software, and more particularly to software that dynamically generates an initial menu page for a client system, such as a TV settop box system, personal digital assistant, or mobile phone, based on the client system user's preferences and history in the use of the client system.

### BACKGROUND OF THE INVENTION

A personal Web guide system, as disclosed in U.S. patent application Publication No. US 2003/0037339 A1, which is explicitly incorporated herein by reference, has made Internet browsing on a non-PC environment easier and more user-friendly. Briefly, the personal Web guide system allows a user of a client system, in particular a computer-novice user who is not familiar with typing on a keyboard or maneuvering a mouse, to enjoy viewing a sequence of Web pages automatically as predefined in a schedule program. In one embodiment, a plurality of categories are displayed on a client system, wherein each of the categories is associated with a schedule program. The user is required to make only one selection, with one click, of a preferred category, and a series of Web pages are automatically displayed on the client system in sequence as predetermined in the schedule program associated with the selected category. The “one click selection” concept is becoming increasingly important as the Internet becomes accessible through a variety of non-PC client systems. A data input device for a non-PC client system, such as a TV settop box system, personal digital assistant (PDA), or mobile phone, typically consists of only arrow keys and number keys. Selection using only arrow keys and number keys becomes tedious after more than two layers of directory.

It is also difficult for and unrealistic to expect users to spend more than a few seconds locating the information they want on these mobile (PDA, mobile phone) and entertainment (TV settop box) systems. When users turn on their TV sets, they expect the information they want to appear on the first screen they see. The most effort that typical users will invest is punching in their favorite channel number, and perhaps pushing the up and down arrows to surf the channels.

While the personal Web guide system, discussed above, has extended the automatic information displaying mechanism of a TV set onto the Internet content based on the use of a predefined schedule program, there still remains a need for a further method that permits a user, in particular a computer-novice user, to easily access various information sources and/or services using their non-PC client systems.

### SUMMARY OF THE INVENTION

The present invention provides a method, system, and software for dynamically generating a customized menu page on a display of a client system, for example a non-PC client system. The menu page is “customized” in the sense that each menu page is generated based on each user's history and preferences, as stored in a user preference database, to present only those information sources/services that he/she would want or expect. The menu is “dynamically” generated in the sense that the user preference database is constantly updated so as to present a menu page that reflects the user's most recent preferences and history.

Simulating the phenomenon that users of TV sets usually have only a set number of favorite channels that they view, the present invention is built on the assumption that users, in particular non-PC client system users, would have only a set number of information sources/services that they routinely use or access on their client systems. The information sources/services may include a certain number of Web guide channels, Internet content and applications, interactive services, and/or phone numbers on the VoIP services. Building on the typical user's TV-watching habit, the present invention allows the users to access their favorite information sources/services in the fastest time possible. The invention also eliminates the trouble of finding the location of the information sources/services, and increases efficiency and user-friendliness in the use of the client system. Specifically, the invention shortens the viewers' access time to the desired information sources/services by displaying, on the first display screen, the most accessed information sources and services in the form of icons. The invention records and calculates (determines) the users' preferred information sources and services, and presents these information sources and services as icons that the users can access with just one click, satisfying the “one click selection” requirement discussed above. The service of dynamically generating a customized menu page is referred to herein as a customized menu page service and the system providing the service is referred to as a customized menu page generation system.

The customized menu page service of the present invention is provided by a system comprising a menu page generator, coupled to a user preference server, which in turn is coupled to (or includes) a user preference database. The system essentially acts as an agent for the users so that the users do not have to click through multiple layers and directories to access their favorite information sources (e.g., Internet content available at specific URLs or at Web guide channels) or services.

The menu page referred to herein is any first page screen that is displayed on any monitor, such as TV, PDA, PC monitors and LCD displays that the users see when they first request the present service. It is the screen that the user will see before having to make any selections using a data input device. The menu page and the icons included in the menu page are coded with Hyper Text Markup Language (HTML) that can be transmitted through either the Internet connection or CATV signals.

The icon referred to herein is a graphic representation of a Web guide script, file, URL, local function that exists on the client system, or any interactive service provided through either the Internet or CATV signals. The icon could be clickable, which means that it can be selected using only arrow keys and/or number keys, without requiring a keyboard. The icons are arranged on the menu page so that they are available on the same screen. The icons can direct the client system to download various files and applications that are either stored locally on the client system, or over the Internet, as well as those that are stored or accessible through other servers of a network. The visual representation of an icon could be in the form of a graphic user interface, such as a graphic button or a Text Message marquee that runs across the screen. For example, a user-specific graphic user interface may include a VoIP phone book that records all the numbers that the user has dialed before. The user preference database would record the user's phone calls and present the most commonly dialed phone numbers on the menu page.

By selecting any of the icons on the menu page or entering the numbers (using the number keys, for example) that are associated with the icons, the user indicates what information sources or services they are interested in, and the user preference server logs the user's activities in the user preference database for further references. In addition to activity logs, the user preference server also stores the users' device (i.e., client system) information, such as the device location and group category, as well as demographic data such as each user's ID number, address, phone numbers, age, gender, etc. Based on this information, the menu page generator would automatically and dynamically generate a unique and personalized menu page for the user each time the user accesses the present service.

The user would require three components to receive the menu page provided by the present service: a display that can exhibit the menu page, an input device such as the one including directional (or arrow) keys, number keys, and an enter key to confirm the user's selection, and a client system (or a “device”) that can be connected through any network to the present service. The client system would require software that could display HTML files, such as a browser.

Before the user makes any selection or action, the present service would access the menu page generator, which determines the content of the menu page for this particular user. Depending on the user's previous experiences and previously collected preferences or demographic data, the menu page for each user would appear differently. The menu page generator is responsible for determining the icons that are to appear on each menu page. The factors that can affect which icons are to appear include user's preferences, user's past activity records, user's demographics, and user's access and privileges.

Accordingly, the menu page generator is a server that determines which icons will appear on a particular user's menu page. Each user would have a unique user profile record stored in the menu page generator. The user profile record is used to identify in the user preference database the user's past activities, demographic information, access and privilege attributes, etc., which can then be used by the menu page generator to build a unique menu page and icon combination for the particular user. Each user must be registered to subscribe to the customized menu page generation service of the present invention in order to receive (view) his/her customized menu page.

Specifically, to determine which files and services the users would most likely want to view or use, the menu page generator connects with the user preference server, which records the user's behaviors and other information in the user preference database. Having recorded data relating to the user's viewing habits and personal information, for example, which Web sites the user has recently visited and the duration of each viewing, the user preference server provides these data to the menu page generator, which then performs calculations based on the provided data to determine which information sources and services the user would most likely want to access again. The user's preferences can also be deduced from the nature and categories of the user's past viewing habits. The menu page generator can also recommend information sources and services to the users based on their previous selections. For example, the menu page can recommend an automobile service to a user who has been viewing the automobile classified section.

The client system's software continuously collects user activity data and transmits the data to the user preference server when the user makes a request to access the menu page service, or automatically even when the user is not using the service. Data such as user's ID, device (i.e., client system) ID, current location, current viewing “channel” (e.g., a series of URLs preprogrammed to be automatically displayed sequentially on a client system according to the Web guide system, as described above) and viewing duration, are all collected by the client software and sent back to the user preference server.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram depicting an illustrative operating environment for implementing a dynamic and customized menu page generation service of the present invention;

FIG. 2 is a block diagram depicting an illustrative architecture of a client system;

FIG. 3 is a block diagram depicting an illustrative architecture of a menu page generator;

FIG. 4 is a block diagram depicting an illustrative architecture of a user preference server;

FIG. 5 is a schematic illustration of a user preference database;

FIG. 6 is a flowchart illustrating the operation of a dynamic and customized menu page generation system of the present invention including a menu page generator and a user preference server;

FIG. 7 is flowchart illustrating the operation of the menu page generator;

FIG. 8 is a flowchart illustrating the steps to be performed by the menu page generator to generate icons on a menu page;

FIG. 9 is a flowchart illustrating the operation of the user preference server;

FIG. 10 is a flowchart illustrating the steps performed in uploading user data from a client system to the user preference server;

FIG. 11 is a data flow diagram illustrating the data flow among the client system, menu page generator, user preference server, user preference database, and various Web servers, in accordance with one embodiment of the present invention;

FIG. 12 is a sample menu page displayed on a client system, presenting a set of available selections in the form of icons;

FIG. 13 is a sample Short Message Service (SMS) scroll displayed on a client system; and

FIG. 14 is a sample remote control that can be used as an input device for a TV settop box system.

### DETAILED DESCRIPTION OF THE PREFERRED EMBODIMENT

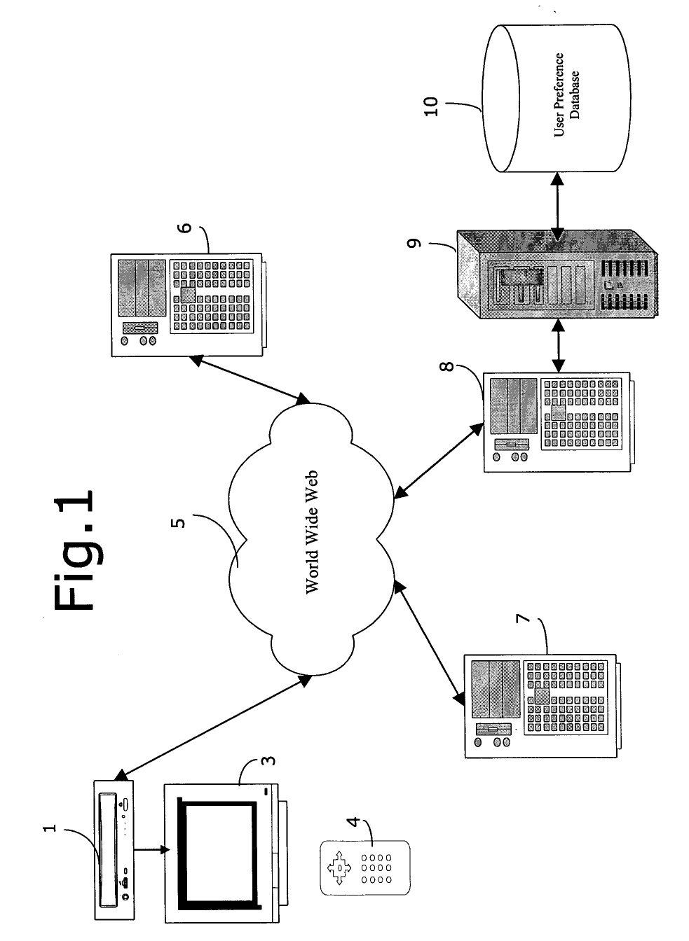

FIG. 1 depicts an illustrative operating environment suitable for implementing a customized menu page generation system of the present invention. One or more client systems 1, such as a TV settop box system, a mobile phone, and a personal digital assistant (palmtop computer), are connected to the Internet 5. In the illustrated embodiment, the client system is a TV settop box connected to, and typically placed on top of, a conventional home TV having a display 3. Also, the TV settop box 1 includes an input device 4, such as an infrared-based remote control device. The client system 1 may be selected from among other types of computing devices, such as a personal computer, a portable computer, pager, and the like, as will be apparent to those skilled in the art. Depending on the type of a client system, the particular configuration of its display 3 and input device 4 will vary, as will be apparent to those skilled in the art.

To view a specific Web page, the client system 1 specifies the URL for the Web page in a request (e.g., a HyperText Transfer Protocol request) using a Web browser executing on the client system. The request is forwarded to the Web server 6 that supports the Web page, and the Web server 6 transmits the Web page (or Web information) to the client system 1 via the Internet 5. The configuration and operation of the Internet are well known in the art, and thus are not described in further detail. It is noted, though, that in accordance with one embodiment of the present invention, a personal Web guide server 7 as disclosed in U.S. patent application Publication No. US 2003/0037339 A1 incorporated hereinabove by reference is also connected to the Internet. Briefly, the personal Web guide server 7 consists of two servers: a host server that supports a schedule program Web page, at which the users of the client systems 1 can select a schedule program; and a schedule program server that constructs a series of Web pages according to a schedule program and to transmit those Web pages to the client system 1 for display.

Still referring to FIG. 1, in accordance with the present invention, a menu page generator 8 is also connected to the Internet 5. The menu page generator 8 is coupled to a user preference server 9, which includes or is coupled to a user preference database 10. The menu page generator 8 dynamically creates HTML files representing a customized menu page including various icons, based on predefined criteria such as each user's preferences and history of access to various information sources, applications, and services over the Internet, as well as each user's personal data, geographical location, and other information. Based on the criteria specified by the menu page generator 8, the user preference server 9 determines which user-related data are to be recorded and maintained. In other words, the user preference server 9 records and maintains in the user preference database 10 those user-related data that are related to or meet the criteria set by the menu page generator 8. Operations of the menu page generator 8 and the user preference server 9 will be more fully described later.

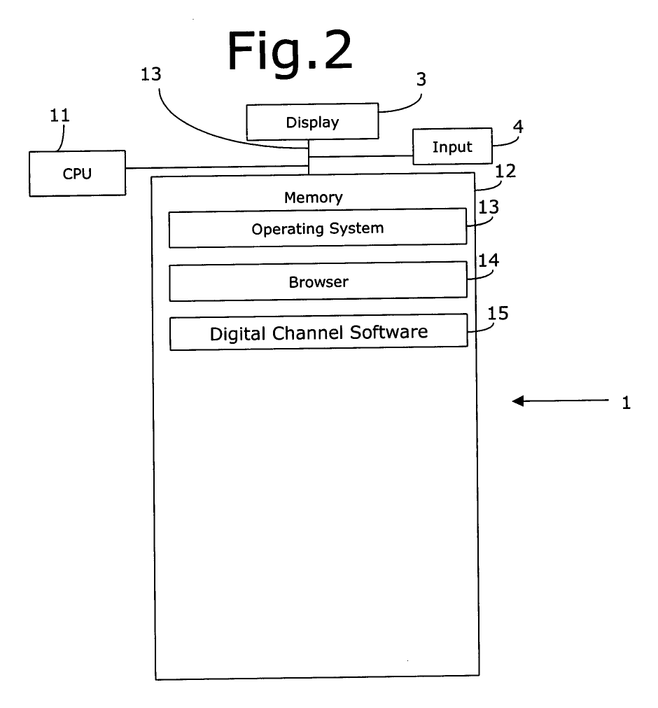

FIG. 2 depicts several key components of an exemplary client system 1. Those of ordinary skill in the art will appreciate that the client system 1 may include many more components than those shown in FIG. 2, such as a network interface for connecting to the Internet. However, it is not necessary that all of these generally conventional components be shown in order to disclose an illustrative embodiment of the present invention. As shown, the client system 1 includes a processing unit 11, a display 3, an input device 4, and memory 12, all interconnected via a bus 13. The display 3 is used to present a customized menu page to the user, in accordance with the present invention. The input device 4 is used by the user to make a desired selection, and may be any conventional input device, including a keyboard, mouse, remote control, pad including arrow keys and number keys, and any other pointing device. In the case of a TV settop box system as shown in FIG. 1, a conventional TV set 3 serves as the display and a remote control device 4 serves as the input device. The memory 12 typically comprises a random-access memory (RAM), a read-only memory (ROM), and a permanent mass storage device, such as a disk storage device, as known in the art. The memory 12 stores an operating system 13 for controlling the operation of the client system 1, and a Web browser 14 for controlling the Web access and interpreting HTML files for the client system 1. The client system 1 also includes digital channel software 15, the operation of which will be more fully described later.

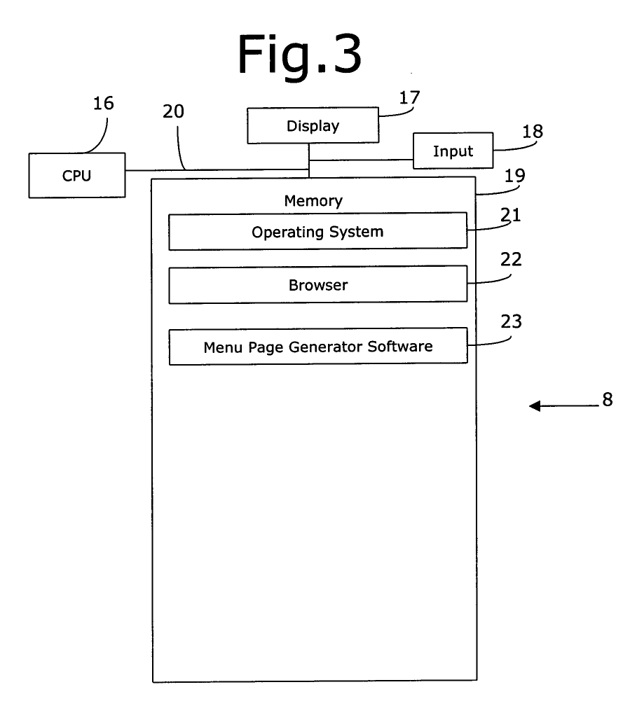

FIG. 3 depicts several of the key components of the menu page generator 8, which may consist of any standard workstation including a server and a host computer as known in the art. As before, those of ordinary skill in the art will appreciate that the menu page generator 8 includes many more components than those shown in FIG. 3, though it is not necessary that all of these generally conventional components be shown in order to disclose an illustrative embodiment of the present invention. As shown in FIG. 3, the menu page generator 8 includes a processing unit 16, a display 17, an input device 18, and mass memory 19, all interconnected via a bus 20. The mass memory 19 stores an operating system 21 for controlling the operation of the menu page generator 8 and a Web browser 22 for controlling the Web access of the menu page generator 8. The mass memory 19 also stores menu page generator software 23, the operation of which will be described in detail later. Basically, the menu page generator 8 defines the criteria based on which a menu page is generated for each user. It also defines what icons will appear in a menu page, whether as a graphic or as a text message scroll (SMS), as well as the layout of the menu page. The menu page generator 8 is the central hub that coordinates with other servers, including the user preference server 9 and perhaps other servers such as the SMS server and the VoIP server, to provide users with the menu page service, perhaps including the SMS and VoIP services. The menu page generator 8 is the server that the client system 1 connects to, when the user requests a customized menu page.

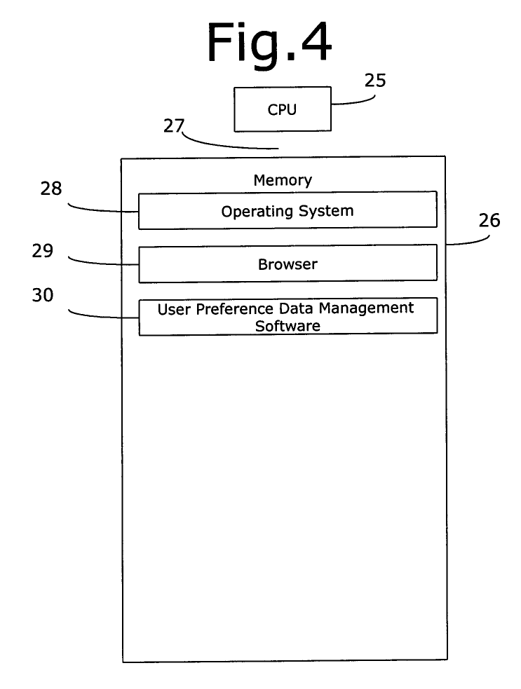

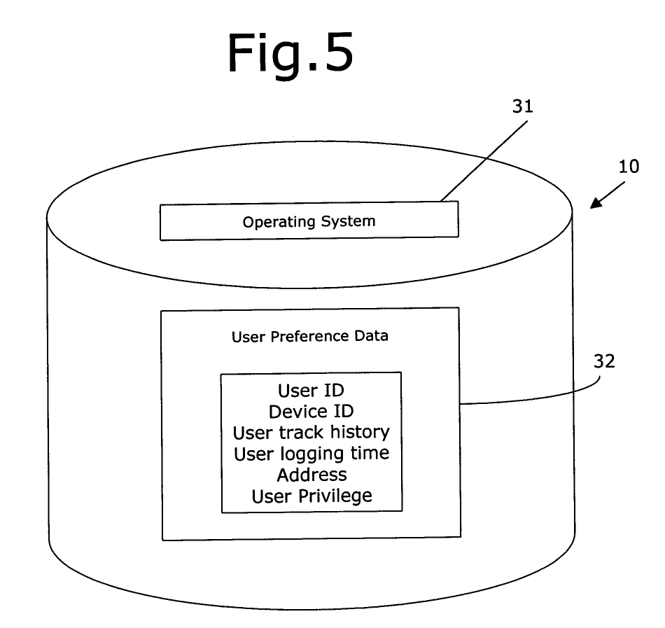

FIG. 4 depicts several of the components of the user preference server 9, which may comprise any standard server system known in the art. As before, those of ordinary skill in the art will appreciate that the user preference server 9 may include many more components than those shown in FIG. 4, though it is not necessary that all of these generally conventional components be shown in order to disclose an illustrative embodiment of the present invention. As shown in FIG. 4, the user preference server 9 includes a processing unit 25 and memory 26 interconnected via a bus 27. The memory 26 stores an operating system 28 for controlling the operation of the server 9, and a browser 29 for controlling the Web access of the server 9. The memory 26 also includes user preference database management software 30, which maintains the user preference database 10. Referring additionally to FIG. 5, the user preference database 10 includes an operating system 31 and memory 32 containing user preference data. The user preference data comprise various user-related data which can be used to assess the preference of each user, such as user ID, device (client system) ID, each user's track history (i.e., network access history), user logging time (including viewing time of each information source/service), personal information (address, phone number, gender, age group, etc.), user privileges, and any other data related to the criteria defined by the menu page generator 8. It should be understood that the user preference server 9 need not be physically independent of the menu page generator 8 described above, and in some cases these two components may be integrally formed. It should also be understood that the user preference database 10 may be physically included in the user preference server 9, or may be merely accessible by the user preference server 9 via a remote connection.

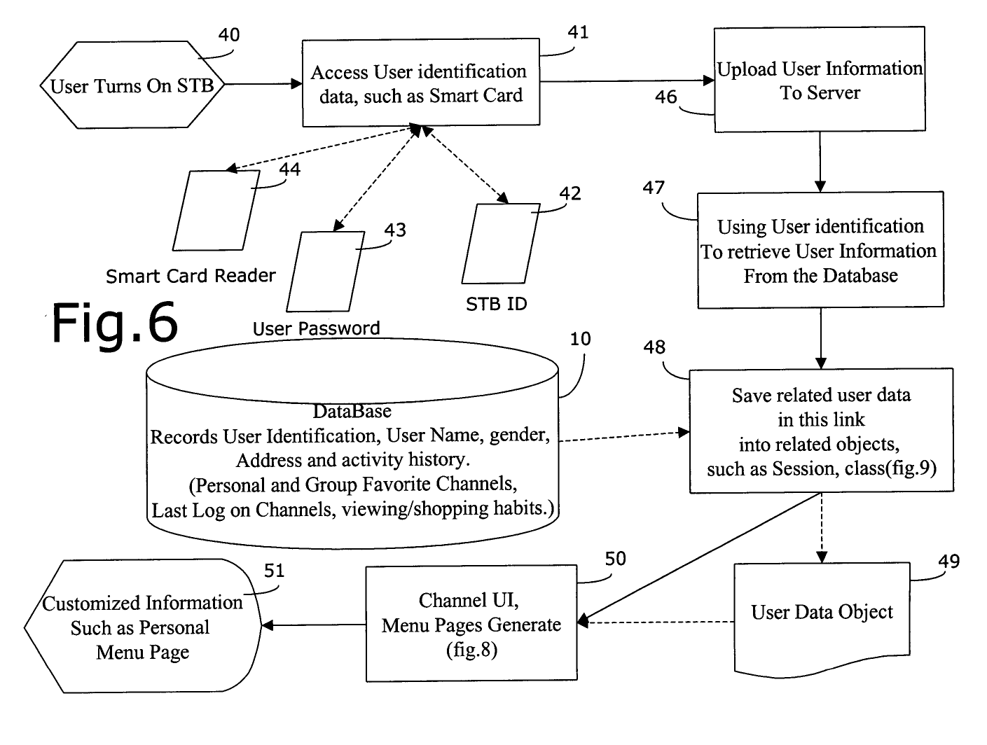

FIG. 6 is a flowchart illustrating the overall flow of a preferred embodiment of the customized menu page generation service of the present invention. In step 40, a user turns on a client system (e.g., a TV settop box) 1, which preferably automatically connects to and requests a menu page from the menu page generator 8. Alternatively, after the client system 1 is turned on, a specific input from the user may be required to request a menu page from the menu page generator 8. In fact, the user of the client system 1 may repeatedly request a new menu page at any moment while the user is using the dynamic and customized menu page generation service. In step 41, the menu page generator 8 compares user identification data received from the client system 1, such as a settop box ID (device ID) 42, user password entered via the input device of the client system 43, or information based on a smart card reader 44, against the user profile record stored within or otherwise accessible by the menu page generator 8. Specifically, the menu page generator 8 verifies if the user who has requested a menu page is a registered menu page service subscriber, if the user belongs to a certain user group, if the user is a subscriber to a premium service, etc.

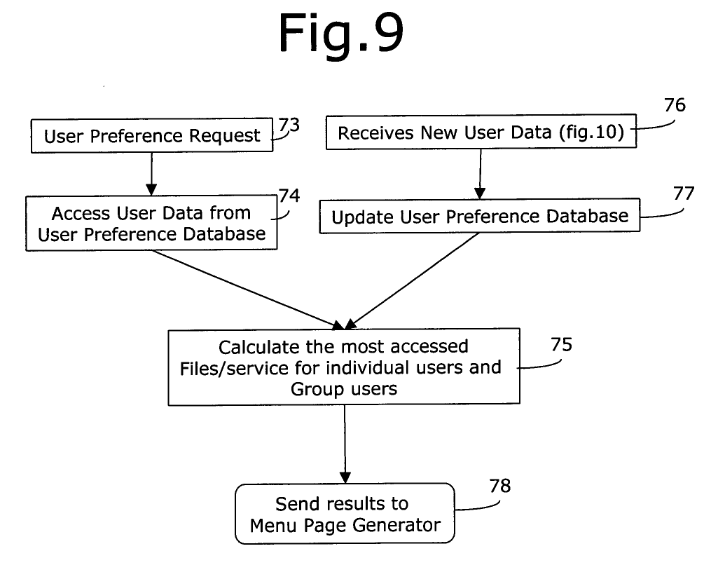

Upon verification, in step 46, the menu page generator 8 uploads the user profile record to the user preference server 9. In step 47, the user preference server 9 uses the received user profile record in order to retrieve various user information related to this particular user from the user preference database 10. For example, the user preference database 10 includes records related to each user's identification, name, gender, address, and activity history (i.e., the user's past activities on the network). The database 10 may also include more specific data, such as each user's personal or group favorite “channels” (i.e., a series of URLs preprogrammed to be automatically displayed sequentially), last logged-on channel, or viewing or shopping habits. In step 48, the user preference server 9 retrieves and saves the user's data which relate to or satisfy the “criteria” defined by the menu page generator 8. For example, the criteria may comprise the frequency or duration at which the user has previously visited particular information sources or services, such as Web guide channels. Then, the data related to the user's previous logging history including the sites and services that the user has visited, as well as the cumulative time that the user has spent at each of the sites and services, are retrieved and saved. The user preference server 9 selects the most often accessed, or the longest-viewing-time site, service, or program, and sends its link in the form of an object, such as session and class, back to the menu page generator 8. The operation of the user preference server 9 will be more fully described later in reference to FIG. 9. Optionally, in step 49, the link may be formatted into a user data object and then sent to the menu page generator 8.

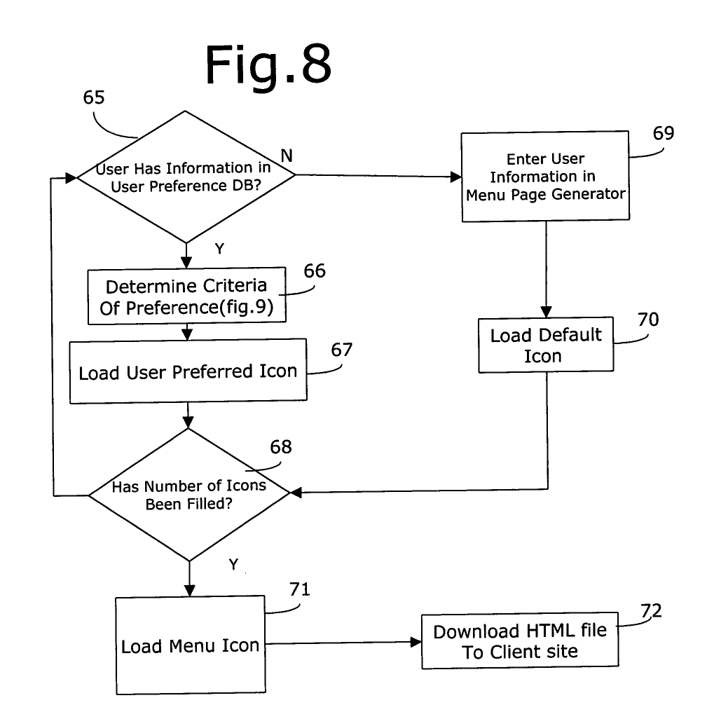

In step 50, the menu page generator 8 dynamically generates a new HTML file representing a menu page that is particularly customized for the user. Specifically, the menu page generator 8 determines and generates icons and graphic user interface (UI) to be included in a menu page for the user. The method of generating a menu page will be more fully described later in reference to FIG. 8. In step 51, the menu page generator 8 sends the generated HTML file to the client system 1, such as a TV settop box, for the user's viewing. When the user then makes a selection on the displayed menu page (e.g., selection of one of the icons displayed), the selected information will be displayed on the client system 1, and at the same time the selection information would be added to the user preference database 10 for use in the next generation of his/her menu page.

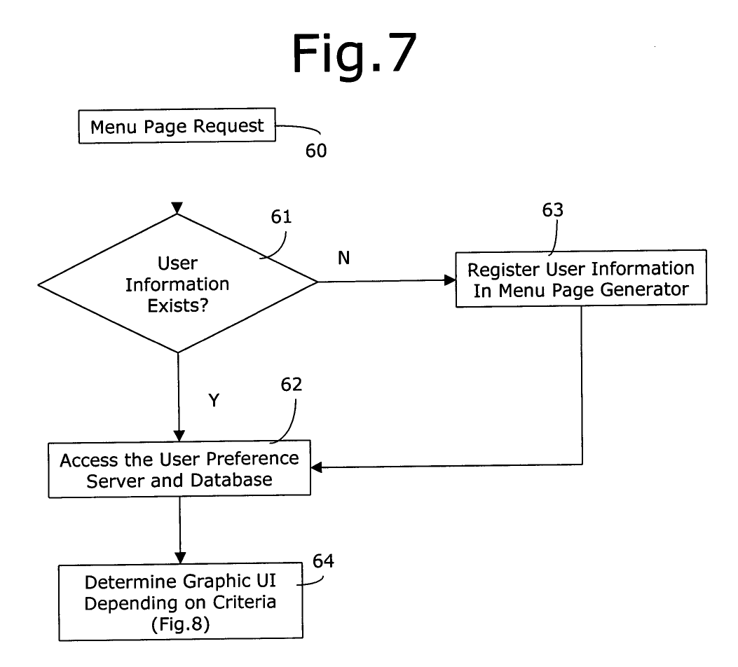

FIG. 7 is a flowchart illustrating the steps performed by the menu page generator 8. FIGS. 7 and 8 collectively describe the operation of the menu page generator software 23 of FIG. 3. In step 60, when a request for a menu page is received from the client system 1, in step 61, the menu page generator 8 searches within itself for the profile record corresponding to the user who has made the request. If the corresponding user profile record exits, in step 62, the menu page generator 8 accesses the user preference server 9 and thus also the user preference database 10 to retrieve the user's data such as the user's history log. On the other hand, if the corresponding user profile record does not exist, in step 63, the menu page generator 8 stores the user profile record of this new user to register the user within the menu page generator 8. Thereafter, again proceeding to step 62, the menu page generator 8 accesses the user preference server 9 and the user preference database 10 to retrieve any data corresponding to the new user. Note that even though the user is new and thus has no personal history log, some data such as what information sources or services are popular amongst certain age groups, can still be retrieved as corresponding to the new user at this time. In step 64, the menu page generator 8, based on its predefined criteria (e.g., formatting the six most recently visited information sources/services into the form of graphic icons), dynamically generates a HTML file for a customized menu page for the particular user using the information retrieved via the user preference server 9. The dynamic menu page generation in step 64 is more fully described in the flowchart of FIG. 8 below.

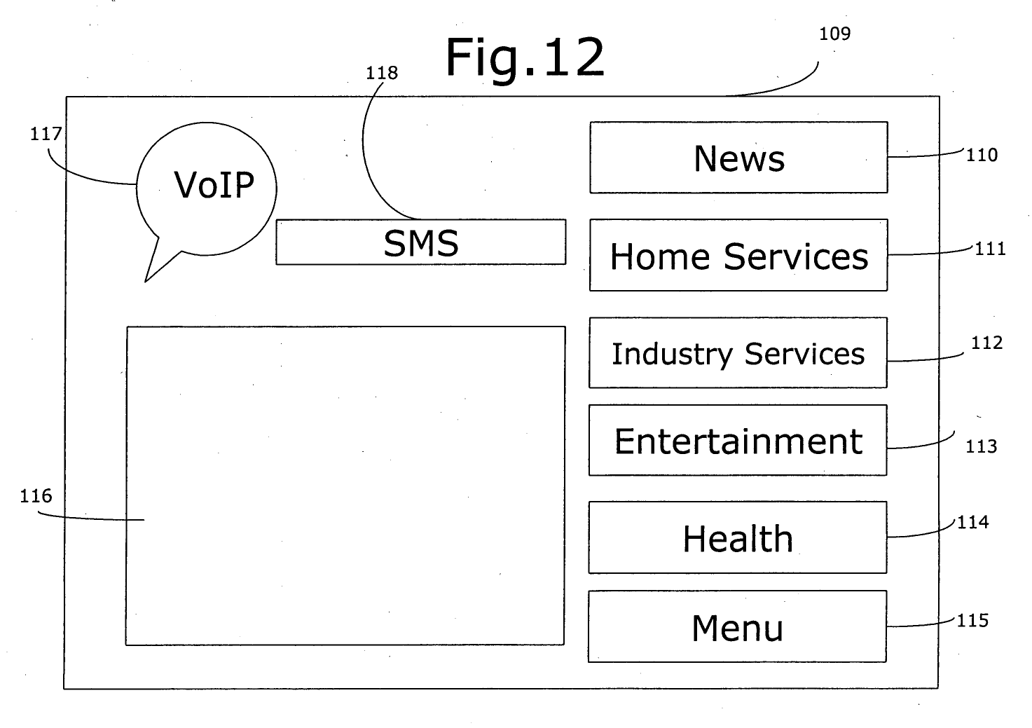

FIG. 8 describes the steps performed to generate a customized menu page. In step 65, it is determined whether the user has any information stored in the user preference database 10. For example, it is determined whether the user has a recorded history of previously viewed (selected) files or services. If so, proceeding to step 66, the menu page generator 8 determines which criteria of preference to use in building a customized menu page. In one embodiment, the criteria comprise the number of times the user has selected a particular Web guide channel. For example, if the user has visited a certain Web guide channel for the most number of times in the past, this Web guide channel is selected. (In one embodiment, the selection is actually performed by the user preference server 9, and its selection process will be described in detail in reference to FIG. 9 below.) Then, in step 67, a link to this channel is loaded in the form of an icon to the menu page generator 8. In step 68, it is determined if all the icons that can be included in a menu page have been filled. For example, referring additionally to FIG. 12, which shows a sample menu page 109, six icons 110-115 are displayed. In this case, in step 68, it is determined if all six icons have been loaded to the menu page generator 8. If not, going back to step 65, the routine repeats itself, and in step 67, this time a link to the Web guide channel that the user has visited secondly most often is loaded in the form of an icon. The routine repeats until in step 68 it is determined that all the icons have been filled. Then, in step 71, all of the icons are loaded into a HTML file representing a particular layout of a menu page including the icons, and in step 72, the HTML file is downloaded to the client system 1 for displaying the menu page thereon.

Referring back to step 65, if it is determined that the user has no history stored in the user preference database 10, or if the user has not made enough selections in the past to fill out the particular menu page layout (e.g., the number of icons), then in step 69, the user's profile information (age, gender, address, etc.) is entered into the menu page generator 8. Then, in step 70, a default icon, such as recommended Web guide channels or group favorite channels (e.g., an icon of a link that is most popular at the present time amongst the group of users having the same or similar profile as the new user) is loaded to the menu page generator 8. Since the user may wish to browse other Web guide channels also, a menu icon (115 in FIG. 12) may be included. When the user selects the menu icon 115, a list (menu) of other Web guide channels or sites/services that the user has not previously selected appears, and the user can select one from the menu.

Note that a menu page may have various layouts and its layout is not limited to the example shown in FIG. 12. For example, the number of icons displayed on a menu page may vary according to the particular criteria used by the menu page generator 8 in generating a menu page. Also, as shown in FIG. 12, the menu page may include icons for other services, such as the VoIP service (117) and SMS service (118).

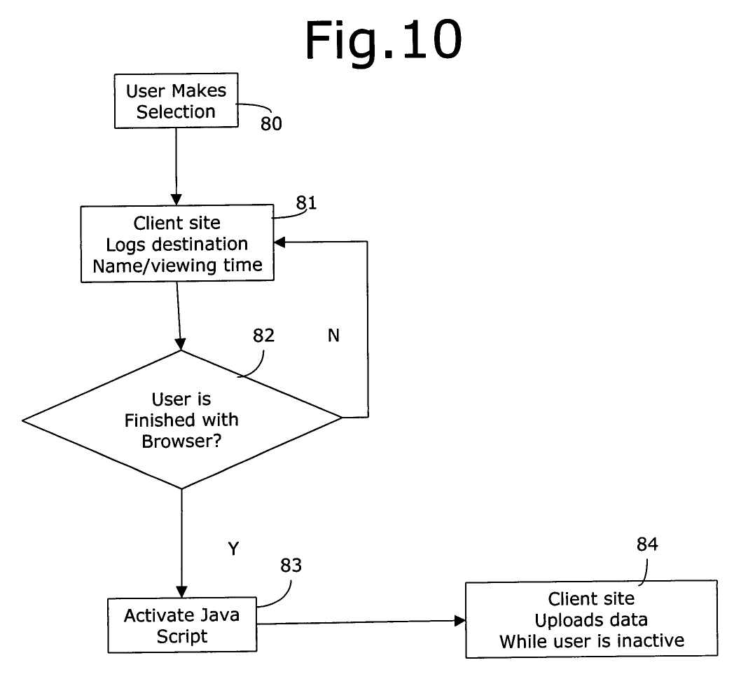

FIG. 9 describes two examples of when the user preference server 9 would be accessed. The operation of the user preference server 9 in managing user preference data is controlled by the user preference data management software 30 of FIG. 4. Referring to step 73, the first scenario is when the menu page generator 8 requests user data from the user preference database 10. Then, the user preference server 9 accesses the user data stored in the user preference database 10 according to the criteria defined by the menu page generator 8. In step 75, based on the criteria (e.g., selecting the six most frequently accessed files/services as the most likely files/services that the user would wish to access again), the user preference server 9 calculates which files/services are the most frequently accessed (tallying up the user's selection frequency and/or logged-on time) for the individual user (or for the group of users to which the user belongs, if the user has no or insufficient history log). Then in step 78, the user preference server 9 sends the results to the menu page generator 8. The second scenario is, referring to step 76, when the client system 1 sends new user data (e.g., any selection that the user makes with respect to the received menu page, such as clicking on one of the icons displayed on the menu page). The operation of the client system 1 in this connection will be more fully described below in reference to FIG. 10. Still referring to FIG. 9, in step 77, the user preference server 9 updates the user preference database 10 based on the new user data received from the client system 1. Then, in step 75, the user preference server 9 may calculate which files/services are most frequently accessed for the user or for the group of users to which the user belongs, and in step 78, send the results to the menu page generator 78.

FIG. 10 describes the process of how user data are collected by the client system 1 and sent back to the user preference server 9 and the user preference database 10, as performed by the digital channel software 15 of the client system 1 in FIG. 2. In step 80, when a user makes a selection on the client system 1, then in step 81, the client system's digital channel software 15 logs the destination (e.g., accessed Web guide channel) and viewing duration (time) as the user continues to view the accessed Web guide channel. In step 82, it is determined whether the user is finished with viewing the channel. If not, going back to step 81, the software continues to log the destination and viewing time. If, on the other hand, the user is finished with viewing the channel, then proceeding to step 83, the browser (22 in FIG. 2) would activate Java script to automatically upload the user data (e.g., the destination and viewing time data) to the user preference server 9 via the menu page generator 8, perhaps without user's prompt when the user is inactive (not requesting the menu page generation service of the present invention). In one embodiment, all the user data are first stored in the client system 1 before being sent to the user preference server 9.

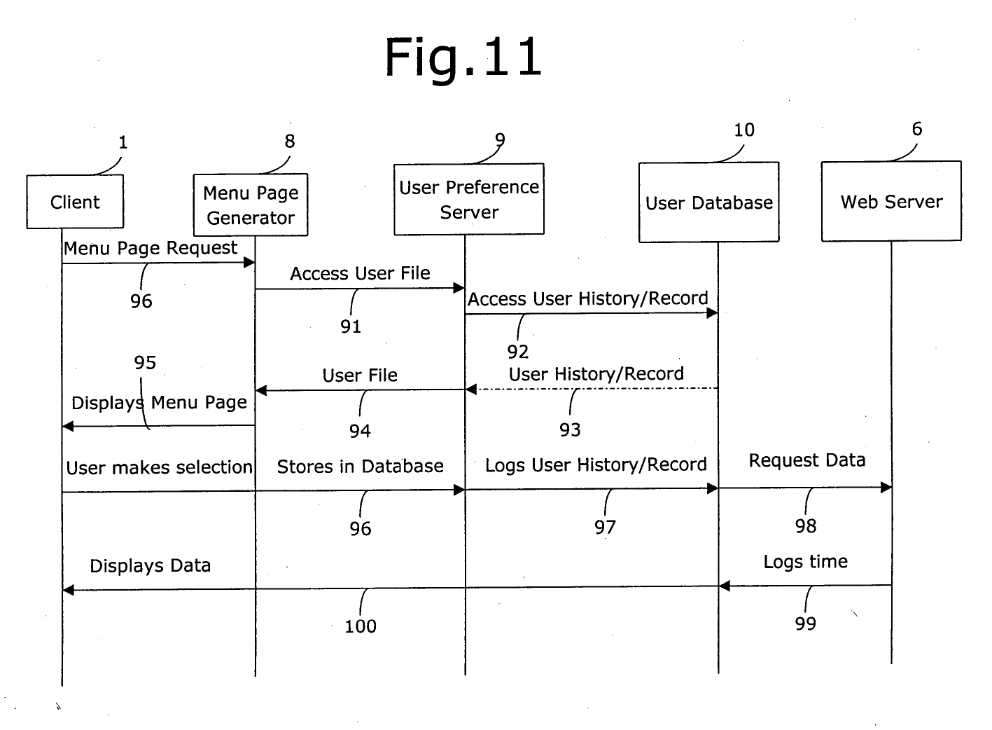

FIG. 11 illustrates the overall data flow in a dynamic and customized menu page generation system in accordance with one embodiment of the present invention. Specifically, FIG. 11 illustrates data flow amongst the client system 1, menu page generator 8, user preference server 9, user preference database 19, and one or more Web servers 6 supporting various Web pages (including the Web guide server 7 as shown in FIG. 1). In addition to the Web servers, other servers such as the VoIP server and SMS server may also be included depending on each application. First, in line 90, the client system 1 sends a request to the menu page generator 8 for a customized menu page. This may be done using any method, e.g., automatically by simply turning on the client system 1 or based on a user input using the input device of the client system 1. In line 91, in response to the request, the menu page generator 8, upon verifying that the user requesting a menu page is pre-registered, accesses the user's file via the user preference server 9. Specifically, in lines 92 and 93, the user preference server 9 accesses and retrieves the user's history/record stored in the user preference database 10, and in line 94, the retrieved user data in the form of a user file is returned to the menu page generator 8. In line 95, the menu page generator 8 generates and sends a customized menu page to the client system 1 for display. In line 96, the user then makes a selection on the displayed menu page, and the selection is passed via the menu page generator 8 to the user preference server 9. In line 97, the user preference server 9 stores the user's new history/record in the user preference database 10, and in line 98, requests the selected data (files/services, etc.) from the Web server 6 supporting the selected data. In lines 99 and 100, the selected data from the Web server 6 are returned to the client system 1 for display, and at the same time the client system 1 logs time during which it continues to view the selected data.

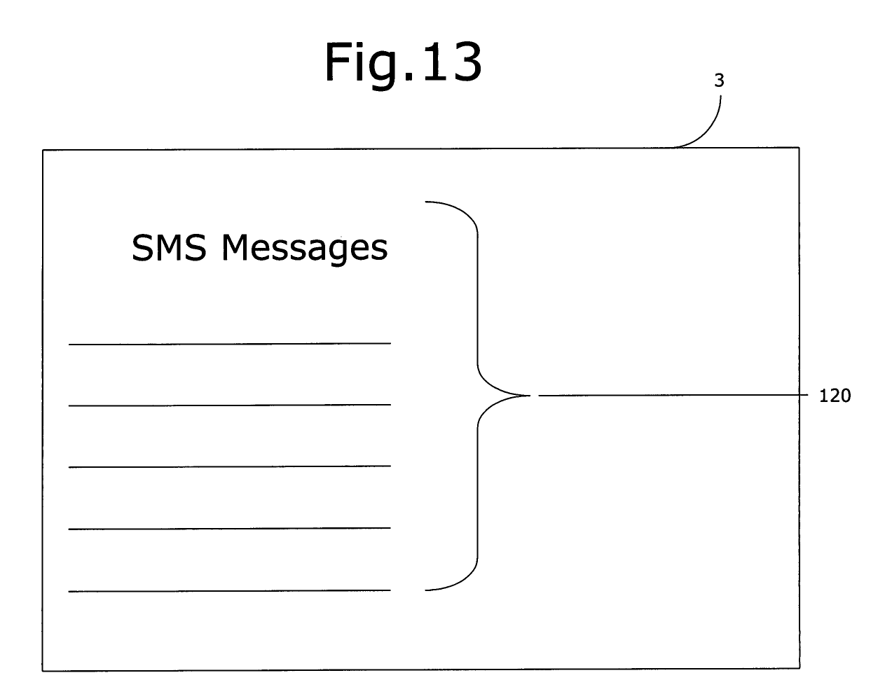

FIG. 12 is a sample menu page 109 generated in accordance with the present invention. The menu page may include a plurality of icons 110-115 each representing a particular file/service/Web guide channel, etc., that a user is likely to wish to view. The menu page 109 may also include a screen for displaying a regular TV channel (in the case when the client system 1 is a TV settop box). The menu page 109 may also include a VoIP icon 117, SMS icon 118, etc., which the user can also select by simply clicking on it to access the respective service associated with it. For example, FIG. 13 is a sample screen on the display 3 when the SMS icon 18 is selected. A SMS scroll 120 appears on the display 3.

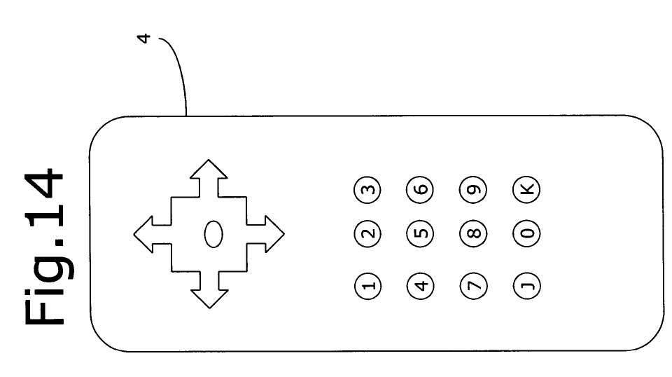

FIG. 14 is a sample remote control 4 including arrow keys and number keys, suitable for use in the present invention as the input device of the client system 1 (TV settop box). According to one aspect, the number keys may be used to specify a particular file, site, service, Web guide channel, etc., available on the network. Specifically, each destination, preferably each of the most popular destinations, is “channelized,” i.e., assigned a specific number (e.g., 4-digit number) that the user can enter using the remote control 4. This is done by associating each number in the remote control 4 with a particular destination on the network, as will be apparent to one skilled in the art. This arrangement permits the users, particularly computer-novice users, to extend their TV viewing habits onto the context of network browsing. For example, just like the user may punch in the number of a TV channel to watch the desired TV channel, the user can punch in the number of a desired Web guide channel to view the desired information on the Web (or any other network on which the present invention is applied.) For example, channels 1-999 may be assigned to TV channels, while channels 1000-9999 may be assigned to Web channels. This arrangement further renders the Internet (or any other network) more accessible to computer-novice users.

It should be appreciated by those skilled in the art that, although the present invention has been described above mostly in reference to the Internet, the invention may be applied in the context of other networks, such as the digital TV network, as well.

While the preferred embodiments of the invention have been illustrated and described, it will be appreciated that various changes can be made therein without departing from the spirit and scope of the invention.

1. A dynamic and customized menu page generation system which allows a user to readily view desired network information, the system comprising:
a user preference server including a user preference database containing data related to each user's history and preferences in his/her network access;
a menu page generator coupled to the user preference server, for dynamically generating a customized menu page for each user based on the user's data retrieved from the user preference server; and
a client system including a display and an input device, the client system being configured to request and receive a menu page from the menu page generator, the menu page presenting a set number of items available for selection by the user, wherein upon the user's selection of one of the items using the input device, information sources and/or services associated with the selected item is automatically rendered available on the display to the user.

2. The system of claim 1, wherein the items available for selection are presented on the menu page in the form of graphic user interfaces.

3. The system of claim 2, wherein the graphic user interfaces comprise graphic icons.

4. The system of claim 1, wherein the menu page generator is further coupled to a specific utility server, and the items available for selection on the menu page include a graphic user interface associated with the specific utility server.

5. The system of claim 4, wherein the specific utility server is selected from the group consisting of a Web guide server, VoIP server, SMS server, and news search engine server.

6. A menu page generator for dynamically generating a customized menu page, which allows a user to readily view desired network information, the generator being coupled to a user preference database containing data related to each user's history and preferences in his/her network access, wherein the generator generates a customized menu page for each of the individual users based on predefined criteria as applied to the data related to the user's history and preferences.

7. The generator of claim 6, wherein the criteria comprise the frequency at which a user has accessed an information source or service on the network in the past.

8. The generator of claim 7, wherein the criteria comprise the number of times that a user has accessed an information source or service on the network and the duration of time of each access.

9. The generator of claim 6, wherein the user's preferences are deduced from the user's demographic data.

10. The generator of claim 6, wherein the user's preferences are deduced from preference data available for the group of users to which the user belongs.

11. The generator of claim 6 which, upon receiving a menu page request from a client system, performs a verification process to authenticate the user of the client system requesting a menu page.

12. The generator of claim 11, wherein the verification process comprises the use of one or more of a user name, user password, smart card, and client system identification number.

13. A user preference server coupled to a menu page generator for dynamically generating a customized menu page based on predefined criteria, the menu page allowing a user to readily view desired network information, the server including a user preference database containing data related to each user's history and preferences in his/her network access, wherein the server performs a calculation to identify the network information that satisfies the criteria defined by the menu page generator, and forwards the information to the menu page generator.

14. The server of claim 13, wherein the criteria comprise the frequency at which a user has accessed an information source or service on the network in the past, and the calculation comprises calculating the number of times that a user has accessed an information source or service on the network and the duration of time of each access.

15. The server of claim 14, which automatically collects, each time a user accesses an information source or service on the network, user log data comprising what information source or service the user accesses on the network for what time duration.

16. A client system coupled via a network to a menu page generator for dynamically generating a customized menu page on the client system, the menu page allowing a user to readily view desired network information, the client system comprising a display, input device, network browsing application, and data collecting software.

17. The system of claim 16, wherein the data collecting software records what information sources or services are accessed on the network by the client system for what time duration.

18. The system of claim 16, wherein the input device comprises arrow keys and number keys.

19. The system of claim 18, wherein the arrow keys or number keys are used to designate a particular information source or service available on the network.

20. The system of claim 18, wherein a predefined set of information sources and services available on the network are pre-associated with numbers that can be entered using the input device.

21. An article comprising a computer-readable signal-bearing medium including computer-executable instructions, wherein the instructions when loaded onto a computer perform the steps of:
receiving a request for a dynamic and customized menu page from a client system over a network;
verifying the identity of a user associated with the client system requesting the menu page;
accessing data related to the user's history and preferences in his/her network access;
generating a customized menu page for the user based on the accessed data; and
sending the generated customized menu page to the client system for display, the menu page presenting a set number of items available on the network for selection by the user, wherein upon the user's selection of one of the items, information sources and/or services associated with the selected item is automatically rendered available on the client system to the user.

22. The article of claim 21, wherein the step of receiving a request for a dynamic and customized menu page from a client system occurs substantially simultaneously upon the client system being turned on.

23. The article of claim 21, wherein the step of receiving a request for a dynamic and customized menu page from a client system occurs anytime while the client system is turned on.

24. The article of claim 21, wherein the step of verifying the identity of a user comprises the use of one or more of a user name, user password, smart card, and client system identification number.

25. The article of claim 21, wherein the items available for selection are presented on the menu page in the form of graphic user interfaces.

26. The article of claim 25, wherein the graphic user interfaces comprise graphic icons.

27. The article of claim 21, wherein the items available for selection on the menu page include a graphic user interface associated with a specific utility server selected from the group consisting of a Web guide server, VoIP server, SMS server, and news search engine server.

28. The article of claim 21, wherein the step of accessing data related to the user's history and preferences comprises accessing data satisfying predefined criteria.

29. The article of claim 28, wherein the criteria comprise the frequency at which a user has accessed an information source or service on the network in the past.

30. The-article of claim 29, wherein the criteria comprise the number of times that a user has accessed an information source or service on the network and the duration of time of each access.

31. The article of claim 21, wherein the step of accessing data related to the user's history and preferences comprises accessing preference data deduced from the user's demographic data.

32. The article of claim 21, wherein the step of accessing data related to the user's history and preferences comprises accessing preference data of the group of users to which the user belongs.

33. The article of claim 21, wherein the computer-executable instructions perform the further step of automatically collecting, each time a user accesses information sources or services on the network, user log data comprising what information source or service the user accesses on the network for what time duration.

34. An article comprising a computer-readable signal-bearing medium including computer-executable instructions, wherein the instructions when loaded onto a client system are capable of performing the steps of:
requesting a dynamic and customized menu page over a network;
receiving and displaying the menu page on a display of the client system, the menu page presenting a set number of items available on the network for selection by a user;
receiving the user's selection of one of the items;
requesting the selected item over the network; and
receiving and displaying the information sources and/or services associated with the selected item on the display of the client system.

35. The article of claim 34, wherein the step of receiving the user's selection of one of the items comprises receiving a numeric entry from the user, wherein a predefined set of information sources and services available on the network are pre-associated with numbers that can be entered by the user.

36. The article of claim 34, wherein the medium further comprises computer-executable instructions which, when loaded onto the client system, perform the step of collecting data related to what information sources or services are accessed over the network by the client system for what time duration.

37. The article of claim 34, wherein the medium is a recordable data storage medium.

38. The article of claim 34, wherein the medium is a modulated carrier signal.

39. A method of dynamic and customized menu page generation to allow a user to readily view desired network information, the method comprising the steps of:
receiving a request for a dynamic and customized menu page from a client system over a network;
verifying the identity of a user associated with the client system requesting the menu page;
accessing data related to the user's history and preferences in his/her network access;
generating a customized menu page for the user based on the accessed data; and
sending the generated customized menu page to the client system for display, the menu page presenting a set number of items available on the network for selection by the user, wherein upon the user's selection of one of the items, information sources and/or services associated with the selected item is automatically rendered available on the client system to the user.

40. The method of claim 39, wherein the step of receiving a request for a dynamic and customized menu page from a client system occurs substantially simultaneously upon the client system being turned on.

41. The method of claim 39, wherein the step of receiving a request for a dynamic and customized menu page from a client system occurs anytime while the client system is turned on.

42. The method of claim 39, wherein the items available for selection are presented on the menu page in the form of graphic icons.

43. The method of claim 39, wherein the step of accessing data related to the user's history and preferences comprises accessing data satisfying predefined criteria.

44. The method of claim 43, wherein the criteria comprise the frequency at which a user has accessed an information source or service on the network in the past.

45. The method of claim 39, further comprising the step of automatically collecting, each time a user accesses an information source or service on the network, user log data comprising what information source or service the user accesses on the network for what time duration.

46. A method of allowing a user of a client system to readily view desired network information, the method comprising:
associating a set of information sources and services available on a network with numbers that can be entered by the user of a client system using an input device;
receiving a numeric entry from the client system; and
displaying the information source or service associated with the received numeric entry on the client system.

47. The method of claim 46, wherein the numeric entry is made by the user using an input device comprising number keys.

48. An article comprising a computer-readable signal-bearing medium including computer-executable instructions, wherein the instructions when loaded onto a client system are capable of performing the steps of:
receiving a numeric entry from a user of the client system via an input device;
transmitting the received numeric entry to a network;
receiving the information source or service associated with the numeric entry from the network; and
displaying the received information source or service on the client system.

49. The article of claim 48, wherein the numeric entry is made by the user using an input device comprising number keys.
